(19) United States
(12) Patent Application Publication
(10) Pub. No.: US 2015/0141542 A1
(43) Pub. Date: May 21, 2015

(54) METHOD FOR PRODUCING FLAME-PROTECTED POLYURETHANE FOAMS HAVING LOW BULK DENSITIES

(71) Applicant: Bayer Material Science AG, Leverkusen (DE)

(72) Inventors: Sven Meyer-Ahrens, Leverkusen (DE); Stefan Lindner, Remscheid (DE); Bert Klesczewski, Koln (DE)

(73) Assignee: BAYER MATERIALSCIENCE AG, Leverkusen (DE)

(21) Appl. No.: 14/399,597

(22) PCT Filed: May 17, 2013
(86) PCT No.: PCT/EP2013/060238

§ 371 Date: Nov. 7, 2014

(30) Foreign Application Priority Data
May 22, 2012 (DE) 12168902.0

(51) Int. Cl. C08G 18/08; C08G 18/32

(52) U.S. Cl. CPC C08G 18/14; C08G 18/3203
USPC 521/174

(57) ABSTRACT

The present invention provides a method for producing flame-retardant polyurethane foams, the resulting flame-retardant polyurethane foams having particularly low densities.

The present invention provides a method for producing flame-retardant polyurethane foams, the resulting flame-retardant polyurethane foams having particularly low densities.

SU-A 600151 discloses a method for producing a modified, flame-retardant polyurethane foam having high mechanical strength. The method is characterised by impregnating the flexible polyurethane foam with water glass, stretching the water glass-impregnated polyurethane foam with a degree of stretch from 10 to 50%, and subsequent curing. The disclosed impregnated, cured polyurethane foams have densities of greater than 90 kg/m³, which are thus well above the conventional densities in the flexible foam industry.

EP-A 0 152 491 discloses a method for producing composite materials by impregnating an expanded organic material, inter alia also polyurethane foam, with an aqueous suspension of insoluble solids additives, preferably layered minerals. These materials display an increased flame retardancy. Impregnation with water glass is not disclosed.

There was a need to provide flame-retardant polyurethane foams having both particularly low densities and good flame retardancy properties. These polyurethane foams must meet the requirements of flammability standard MVSS 302.

Surprisingly this object is achieved by a method for producing flame-retardant polyurethane foams comprising the following steps:
1) producing a flexible polyurethane foam, preferably a flexible polyurethane slabstock foam, obtainable by reacting

Component A:
A1 100 parts by weight of compounds containing isocyanate-reactive hydrogen atoms and having a hydroxyl value (OH value) in accordance with DIN 53240 from 3 mg KOH/g to 140 mg KOH/g,
A2.1 0.5 to 25 parts by weight of water (per 100 parts by weight of A1)
A2.2 0 to 25 parts by weight (per 100 parts by weight of A1) of physical blowing agent, preferably carbon dioxide,
A3 0 to 10 parts by weight, preferably 0 to 5 parts by weight (per 100 parts by weight of A1) of compounds containing optionally isocyanate-reactive hydrogen atoms and having an OH value from 140 mg KOH/g to 900 mg KOH/g,
A4 0.05 to 10 parts by weight, preferably 0.2 to 4 parts by weight (per 100 parts by weight of A1) of auxiliary agents and additives, such as
   a) catalysts,
   b) surface-active additives,
   c) pigments or flame retardants, and

Component B:
B di- and/or polyisocyanates, preferably aromatic polyisocyanates,
   wherein production takes place with an isocyanate index from 70 to 120, preferably from 75 to 115, and
   wherein the indicated parts by weight of components A2 to A4 relate to 100 parts by weight of component A1,
2) impregnating the flexible polyurethane foam produced in step 1 with aqueous sodium and/or potassium silicate solution, preferably sodium silicate solution,
3) periodic compacting and/or rolling of the impregnated polyurethane foam from step 2), then
4) drying the polyurethane foam obtainable in accordance with step 3).

The invention also provides the polyurethane foam produced by the method according to the invention.

In an embodiment of the invention the flexible polyurethane foam from step 1), preferably a flexible polyurethane slabstock foam, has a density of less than 25 kg/m³, preferably less than 15 kg/m³, particularly preferably less than 13 kg/m³.

### Step 1

Production of the flexible polyurethane foams, preferably isocyanate-based flexible polyurethane slabstock foams, in step 1 takes place by known methods. The components described in more detail below can be used to produce the flexible polyurethane foams.

### Component A1

Compounds according to component A1 are compounds containing isocyanate-reactive hydrogen atoms and having a hydroxyl value (OH value) in accordance with DIN 53240 from 3 mg KOH/g to 140 mg KOH/g.

Production of compounds according to component A1 takes place by adding alkylene oxides to starter compounds containing isocyanate-reactive hydrogen atoms. These starter compounds mostly have functionalities from 2 to 8, preferably from 2 to 6, particularly preferably 3, and are preferably hydroxy-functional. Examples of hydroxy-functional starter compounds are propylene glycol, ethylene glycol, diethylene glycol, dipropylene glycol, 1,2-butanediol, 1,3-butanediol, 1,4-butanediol, hexanediol, pentanediol, 3-methyl-1,5-pentanediol, 1,12-dodecanediol, glycerol, trimethylolpropane, triethanolamine, pentaerythritol, sorbitol, sucrose, hydroquinone, catechol, resorcinol, bisphenol F, bisphenol A, 1,3,5-trihydroxybenzene, methylol group-containing condensates of formaldehyde and phenol or melamine or urea. Glycerol and/or trimethylolpropane are preferably used as the starter compound.

Suitable alkylene oxides are for example ethylene oxide, propylene oxide, 1,2-butylene oxide or 2,3-butylene oxide and styrene oxide. Propylene oxide and ethylene oxide are preferably fed to the reaction mixture individually, as a mixture or in succession. If the alkylene oxides are added in succession, the products that are produced (polyether polyols) contain polyether chains having block structures. Products having ethylene oxide end blocks are characterised for example by elevated concentrations of primary end groups, which give the systems an advantageous isocyanate reactivity.

The functionality of the polyether polyols is determined by the functionality of the starter compounds used to produce the polyether polyols.

In one embodiment component A1 has an oxyethylene content from 0 to 20 wt. %.

In a further embodiment component A1 has an oxyethylene content of >60 wt. %, preferably >70 wt. %.

In a further embodiment component A1 has an oxyethylene content from 0 to 30 wt. %, preferably from 10 to 20 wt. %.

Mixtures of component A1 can also be included.

In a preferred embodiment component A1 contains 100 parts by weight of a polyether polyol having an OH value in accordance with DIN 53240 from 3 mg KOH/g to 140 mg KOH/g, a functionality from 2 to 8, preferably from 2 to 6, particularly preferably 3, and an oxyethylene content from 0 to 20 wt. %.

In a further preferred embodiment component A1 contains
A1.1 at least one polyether polyol having a functionality from 2 to 8, preferably from 2 to 6, particularly preferably 3, an oxyethylene content of >60 wt. %, preferably >70 wt. %, more than 50% primary OH groups, preferably 75 to 85% primary OH groups, and an OH value in accordance with DIN 53240 from ≧10 mg KOH/g to ≦112 mg KOH/g, preferably from ≧25 mg KOH/g to ≦45 mg KOH/g, and
A1.2.1 at least one polyether polyol having a functionality from 2 to 8, preferably from 2 to 6, particularly preferably 3, an oxyethylene content from 0 to 30 wt. %, preferably 0 to 15 wt. %, less than 50% primary OH groups, preferably 30 to 45% primary OH groups, and an OH value in accordance with DIN 53240 from ≧42 mg KOH/g to ≦56 mg KOH/g, and/or
A1.2.2 at least one polyether polyol having a functionality from 2 to 8, preferably from 2 to 6, particularly preferably 3, an oxyethylene content from 0 to 30 wt. %, preferably 10 to 20 wt. %, more than 50% primary OH groups, preferably 75 to 95% primary OH groups, and an OH value in accordance with DIN 53240 from ≧28 mg KOH/g to ≦35 mg KOH/g,
the indicated parts by weight of components A1.1, A1.2.1 and A1.2.2 adding to 100.

In this embodiment component A1 particularly preferably contains
A1.1 60 to 90 parts by weight of a polyether polyol having a functionality from 2 to 8, preferably from 2 to 6, particularly preferably 3, an oxyethylene content of >60 wt. %, preferably >70 wt. %, more than 50% primary OH groups, preferably 75 to 85% primary OH groups, and an OH value in accordance with DIN 53240 from ≧10 mg KOH/g to ≦112 mg KOH/g, preferably from ≧25 mg KOH/g to ≦45 mg KOH/g, and
A1.2.1 10 to 40 parts by weight of a polyether polyol having a functionality from 2 to 8, preferably from 2 to 6, particularly preferably 3, an oxyethylene content from 0 to 30 wt. %, preferably 0 to 15 wt. %, less than 50% primary OH groups, preferably 30 to 45% primary OH groups, and an OH value in accordance with DIN 53240 from ≧42 mg KOH/g to ≦56 mg KOH/g, and/or
A1.2.2 10 to 40 parts by weight of a polyether polyol having a functionality from 2 to 8, preferably from 2 to 6, particularly preferably 3, an oxyethylene content from 0 to 30 wt. %, preferably 10 to 20 wt. %, more than 50% primary OH groups, preferably 75 to 95% primary OH groups, and an OH value in accordance with DIN 53240 from ≧28 mg KOH/g to ≦35 mg KOH/g,
the indicated parts by weight of components A1.1, A1.2.1 and A1.2.2 adding to 100.

In a further embodiment polyether carbonate polyols can also be used as component A1, such as are obtainable for example by catalytic reaction of alkylene oxides (epoxides) and carbon dioxide in the presence of H-functional starter substances (see for example EP-A 2046861). These polyether carbonate polyols generally have a hydroxyl functionality of at least 1, preferably from 2 to 8, particularly preferably from 2 to 6 and most particularly preferably from 2 to 4. The OH value is preferably from ≧3 mg KOH/g to ≦140 mg KOH/g, particularly preferably from ≧10 mg KOH/g to ≦112 mg KOH/g.

Component A1 can also contain polymer polyols, a PUD polyol or a PIPA polyol. Polymer polyols are polyols which contain proportions of solid polymers produced by radical polymerisation of suitable monomers such as styrene or acrylonitrile in a base polyol. PUD (polyurea dispersion) polyols are produced for example by in-situ polymerisation of an isocyanate or an isocyanate mixture with a diamine and/or hydrazine in a polyol, preferably a polyether polyol. The PUD dispersion is preferably produced by reacting an isocyanate mixture used from a mixture of 75 to 85 wt. % of 2,4-toluylene diisocyanate (2,4-TDI) and 15 to 25 wt. % of 2,6-toluylene diisocyanate (2,6-TDI) with a diamine and/or hydrazine in a polyether polyol, preferably a polyether polyol produced by alkoxylation of a trifunctional starter (such as for example glycerol and/or trimethylolpropane). Methods for producing PUD dispersions are described for example in U.S. Pat. No. 4,089,835 and U.S. Pat. No. 4,260,530. PIPA polyols are polyether polyols modified by polyisocyanate polyaddition with alkanolamines. PIPA polyols are described in detail in GB 2 072 204 A, DE 31 03 757 A1 and U.S. Pat. No. 4,374,209 A.

### Component A2.1

Water in amounts from 0.5 to 25 parts by weight (per 100 parts by weight of A1) is used as component A2.1.

### Component A2.2

A physical blowing agent, preferably carbon dioxide, in amounts from 0 to 25 parts by weight (per 100 parts by weight of A1) is used as component A2.2.

In a preferred embodiment of the method according to the invention water (component A2.1) is used in amounts from 0.5 to 10 parts by weight, particularly preferably 1.5 to 5.5 parts by weight (per 100 parts by weight of A1) and carbon dioxide (component A2.2) in amounts from 0 to 25 parts by weight, preferably from 0 to 4 parts by weight (per 100 parts by weight of A1).

In a further preferred embodiment water (A2.1) is used in amounts of at least 6 parts by weight (per 100 parts by weight of A1), particularly preferably in amounts from 6 to 12 parts by weight (per 100 parts by weight of A1) and carbon dioxide dissolved under pressure (A2.2) in an amount of at least 6 parts by weight, particularly preferably in amounts from 6 to 12 parts by weight (per 100 parts by weight of A1).

### Component A3

Compounds containing at least two isocyanate-reactive hydrogen atoms and having an OH value from 140 mg KOH/g to 900 mg KOH/g are optionally used as component A3. These are understood to be compounds containing hydroxyl groups and/or amino groups and/or thiol groups and/or carboxyl groups, preferably compounds containing hydroxyl groups and/or amino groups, which serve as chain extenders or crosslinking agents. These compounds generally contain 2 to 8, preferably 2 to 4 isocyanate-reactive hydrogen atoms. Ethanolamine, diethanolamine, triethanolamine, sorbitol and/or glycerol for example can be used as component A3. Further examples of compounds according to component A4 are described in EP-A 0 007 502, pages 16-17.

### Component A4

Auxiliary agents and additives are used as component A4, such as
a) catalysts (activators),
b) surface-active additives (surfactants), such as emulsifiers and conventional foam stabilisers,
c) additives such as reaction retarders (e.g. acid-reactive substances such as hydrochloric acid or organic acid halides), cell regulators (such as for example paraffins or fatty alcohols or dimethyl polysiloxanes), pigments, dyes, flame retardants (such as for example tricresyl phosphate), stabilisers against ageing and weathering influences, plasticisers, fungistatic and bacteriostatic substances, fillers (such as for example barium sulfate, kieselguhr, carbon black or prepared calcium carbonate), and release agents.

These auxiliary agents and additives which can optionally additionally be used are described for example in EP-A 0 000 389, pages 18 to 21. Further examples of auxiliary agents and additives which can optionally additionally be used as well as details of the method of use and mode of action of these auxiliary agents and additives are described in Kunststoff-Handbuch, Volume VII, edited by G. Oertel, Carl-Hanser-Verlag, Munich, 3rd edition, 1993, for example on pages 104-127.

Aliphatic tertiary amines (for example trimethylamine, tetramethyl butanediamine), cycloaliphatic tertiary amines (for example 1,4-diaza(2,2,2)bicyclooctane), aliphatic amino ethers (for example dimethylaminoethyl ether and N,N,N-trimethyl-N-hydroxyethyl bisaminoethyl ether), cycloaliphatic amino ethers (for example N-ethylmorpholine), aliphatic amidines, cycloaliphatic amidines, urea, derivatives of urea (such as for example aminoalkyl ureas, see for example EP-A 0 176 013, in particular (3-dimethylaminopropylamine) urea) and tin catalysts (such as for example dibutyl tin oxide, dibutyl tin dilaurate, tin octoate) are preferably used as catalysts.

The following are particularly preferably used as catalysts:
α) urea, urea derivatives and/or
β) tin catalysts, preferably dibutyl tin oxide, dibutyl tin dilaurate, tin octoate, particularly preferably tin octoate, and/or
γ) tertiary amines (for example 1,4-diaza(2,2,2)bicyclooctane), aliphatic amino ethers (for example dimethylaminoethyl ether).

### Component B

Aliphatic, cycloaliphatic, araliphatic, aromatic and heterocyclic polyisocyanates are used as component B, such as are described for example by W. Siefken in Justus Liebigs Annalen der Chemie, 562, pages 75 to 136, for example those of formula (I)

Q(NCO)ₙ (I)

in which
n=2 to 4, preferably 2 to 3,
and
Q denotes an aliphatic hydrocarbon residue having 2 to 18, preferably 6 to 10 C atoms, a cycloaliphatic hydrocarbon residue having 4 to 15, preferably 6 to 13 C atoms or an araliphatic hydrocarbon residue having 8 to 15, preferably 8 to 13 C atoms.

The polyisocyanates are for example those described in EP-A 0 007 502, pages 7 to 8. The technically easily accessible polyisocyanates, e.g. 2,4- and 2,6-toluylene diisocyanate, as well as any mixtures of these isomers (“TDI”); polyphenyl polymethylene polyisocyanates, such as are produced by aniline-formaldehyde condensation and subsequent phosgenation (“crude MDI”) and polyisocyanates containing carbodiimide groups, urethane groups, allophanate groups, isocyanurate groups, urea groups or biuret groups (“modified polyisocyanates”), in particular modified polyisocyanates derived from 2,4- and/or 2,6-toluylene diisocyanate or from 4,4′- and/or 2,4′-diphenylmethane diisocyanate, are preferably used as a rule. At least one compound selected from the group consisting of 2,4- and 2,6-toluylene diisocyanate, 4,4′- and 2,4′- and 2,2′-diphenylmethane diisocyanate and polyphenyl polymethylene polyisocyanate (“polynuclear MDI”) are preferably used as the polyisocyanate.

The isocyanate index indicates the ratio of the amount of isocyanate actually used to the stoichiometric, i.e. calculated amount of isocyanate groups (NCO):

Isocyanate index=[(amount of isocyanates used):(calculated amount of isocyanates)]·100 (II)

Production of the polyurethane foams according to the invention in step 1 takes place with an isocyanate index from 75 to 120, preferably from 75 to 115.

### Performing the Method According to Step 1

The polyurethane foams can be produced by various methods of slabstock foam production. To perform the method according to the invention the reaction components are reacted by the single-stage method known per se, the prepolymer method or the semi-prepolymer method, wherein mechanical equipment as described in U.S. Pat. No. 2,764,565 is preferably used. Details of processing equipment which can also be used according to the invention are described in Vieweg and Hochtlen (eds): Kunststoff-Handbuch, Volume VII, Carl-Hanser-Verlag, Munich 1966, pages 121 to 205.

The flexible polyurethane foams can also be produced in a continuous method known per se under reduced pressure at 700 mbar to 900 mbar, as described for example in M. Clockaerts, R. Mortelmans Variable Pressure Foaming in Continuous Slabstock Production, Utech 1994.

The flexible polyurethane foams are preferably produced by continuous slabstock foaming (see for example “Kunststoffhandbuch”, Volume VII, Carl Hanser Verlag, Munich, Vienna, 3rd edition 1993, p. 195) or by discontinuous foaming in boxes (see for example “Kunststoffhandbuch”, Volume VII, Carl Hanser Verlag, Munich, Vienna, 3rd edition 1993, p. 203).

The method according to the invention is preferably applied to flexible polyurethane foams with a density (also known as bulk density) of less than 25 kg/m³, preferably less than 15 kg/m³, particularly preferably less than 13 kg/m³.

### Step 2

In step 2 the flexible polyurethane foam produced in step 1 is impregnated with an aqueous sodium and/or potassium silicate solution (“water glass”), preferably with an aqueous sodium silicate solution. To this end the flexible polyurethane foam from step 1 is completely immersed in water glass.

The term water glass refers to glass-like, in other words amorphous, water-soluble sodium and potassium silicates solidified from a melt or aqueous solutions thereof. The general formula M₂O.nSiO₂ of technically important water glasses, which is dependent on the composition of the batch, can be in the approximate range of n equals 1 to 4, preferably 3 to 4. M can be sodium or potassium, sodium being preferred. According to the invention an aqueous sodium silicate solution having a solids content of 38.0% and a molar ratio of SiO₂:Na₂O of 3.4 is preferably used in step 2.

The silicate solution can also be added in an amount of up to 10 wt. % to commercial film-forming polymers on an organic basis known per se in aqueous dispersion, such as for example acrylate dispersions or polyurethane dispersions. Acrylate dispersions are for example pure acrylate dispersions of a copolymer based on alkyl acrylates such as for example butyl and methyl methacrylate, ethyl and methyl methacrylate or dispersions of a copolymer based on acrylic acid esters and vinyl acetate. Polyurethane dispersions are for example anionic aliphatic polyester-polyurethane dispersions, ionic/non-ionic polycarbonate ester-polyurethane dispersions or aliphatic polycarbonate ester-polyether-polyurethane dispersions. These dispersions all have a solids content of between 20 and 60 wt. %.

### Step 3

The water glass-saturated flexible foam obtained in step 2 is rolled in a duo rolling mill consisting of two parallel rollers. The desired degree of saturation can be adjusted selectively by adjusting the gap between the two parallel rollers or by repeating the rolling operation. The degree of saturation is chosen such that the desired final density of the impregnated foam is achieved after removing the water contained in the silicate solution by drying.

### Step 4

The polyurethane foam obtainable in accordance with step 3 is dried for 60 to 120 h, preferably for 65 to 80 h, at a temperature from 20 to 30° C., preferably at 22 to 27° C., and for a further 2 to 10 h, preferably 2 to 7 h, at a temperature from 80 to 120° C., preferably from 90 to 110° C.

The polyurethane foams produced by the method according to the invention are characterised by high flame retardancy in accordance with MVSS 302 and by a density of less than 85 kg/m³, preferably less than 60 kg/m³, particularly preferably less than 50 kg/m³.

In a preferred embodiment the polyurethane foams produced by the method according to the invention have a density of ≦45 kg/m³ and ≧38 kg/m³ and a high flame retardancy in accordance with MVSS 302.

In a further preferred embodiment the polyurethane foams produced by the method according to the invention have a density of ≦30 kg/m³ and ≧23 kg/m³ and a high flame retardancy in accordance with MVSS 302.

The polyurethane foams produced according to the invention can be used inter alia in the construction industry, automotive industry and/or furniture industry.

### EXAMPLES

### Component A1

A1: Glycerol-started polyether containing approx. 10 wt. % ethylene oxide and approx. 90 wt. % propylene oxide as a mixed block, with less than 50% primary OH groups and an OH value of 48 mg KOH/g
A1-1: Glycerol-started polyether containing approx. 72 wt. % ethylene oxide and approx. 28 wt. % propylene oxide, more than 50% primary OH groups and an OH value of 37 mg KOH/g
A1-2-1: Glycerol-started polyether containing approx. 10 wt. % ethylene oxide and approx. 90 wt. % propylene oxide as a mixed block, with less than 50% primary OH groups and an OH value of 48 mg KOH/g

Component A2.1: Water

Component A2.2: Carbon dioxide dissolved under pressure

Component A4:
A4a-1: Amine activator 1: Niax® Catalyst A1
A4a-2: Amine activator 1: Dabco® 33 LV
A4a-3: Tin catalyst Addocat® SO
A4b-1: Silicone stabiliser Tegostab® B8232
A4b-2: Silicone stabiliser BF 2370

### Component B:

B-1: TDI 80/20 (mixture of 2,4- and 2,6-TDI in the weight ratio 80:20 and with an NCO content of 48 wt. %).
Sodium silicate 38/40: Aqueous sodium silicate solution with a solids content of approx. 38.0 wt. %, a density of 1.37 g/cm³ and a molar ratio of SiO₂:Na₂O of 3.4 (weight ratio 3.3) from Woellner GmbH & Co. KG, DE.

The molar proportion of primary OH groups is determined by ¹H-NMR spectroscopy (Bruker DPX 400, deuterochloroform):

To determine the content of primary OH groups the polyether polyol samples were first peracetylated.

The following peracetylation mixture was used:

9.4 g acetic acid anhydride, reagent-grade
1.6 g acetic acid, reagent-grade
100 ml pyridine, reagent-grade

For the peracetylation reaction 10 g of polyether polyol were weighed into a 300 ml ground-glass Erlenmeyer flask. The volume of peracetylation mixture was governed by the OH value of the polyether polyol to be peracetylated, wherein (relative in each case to 10 g of polyether polyol) the OH value of the polyether polyol is rounded to the nearest decimal place; then 10 ml of peracetylation mixture are added per 10 mg KOH/g. For example, 50 ml of peracetylation mixture were added correspondingly to the sample of 10 g of a polyether polyol having an OH value of 45.1 mg KOH/g.

After adding glass boiling chips the ground-glass Erlenmeyer flask was fitted with a riser (air cooler) and the sample was refluxed weakly for 75 min. The sample mixture was then transferred to a 500 ml round-bottomed flask and volatile constituents (substantially pyridine, acetic acid and excess acetic acid anhydride) were distilled off over a period of 30 min at 80° C. and 10 mbar (absolute). The distillation residue was then supplemented three times with in each case 100 ml of cyclohexane (alternatively toluene was used in cases where the distillation residue did not dissolve in cyclohexane) and volatile constituents were removed every 15 min at 80° C. and 400 mbar (absolute). Then volatile constituents were removed from the sample for one hour at 100° C. and 10 mbar (absolute).

In order to determine the molar proportions of primary and secondary OH end groups in the polyether carbonate polyol, the sample prepared in this way was dissolved in deuterated chloroform and examined by ¹H-NMR (Bruker, DPX 400, 400 MHz, pulse programme zg30, waiting time d1: 10 s, 64 scans). The relevant resonances in ¹H-NMR (relative to TMS=0 ppm) are as follows:

Methyl signal of a peracetylated secondary OH end group: 2.04 ppm

Methyl signal of a peracetylated primary OH end group: 2.07 ppm

The molar proportion of secondary and primary OH end groups is then calculated as follows:

Prop. secondary OH end groups (CH—OH)=F(2.04)/(F(2.04)+F(2.07))*100% (III)

Prop. primary OH end groups (CH2-OH)=F(2.07)/(F(2.04)+F(2.07))*100% (IV)

In formulae (III) and (IV) F denotes the resonance surface area at 2.04 ppm and 2.07 ppm respectively.

### Production of Polyurethane Foams (Step 1)

The starting components are processed by slabstock foaming in the single-stage method under the usual processing conditions for the production of polyurethane foams. Table 1 shows the isocyanate index for processing (which gives the amount of component B to be used in relation to component A).

The isocyanate index indicates the ratio of the amount of isocyanate actually used to the stoichiometric, i.e. calculated amount of isocyanate groups (NCO):

Isocyanate index=[(amount of isocyanates used):(calculated amount of isocyanates)]·100 (II)

The density was determined in accordance with DIN EN ISO 3386-1-98.

The OH value was determined in accordance with DIN 53240.

The fire behaviour was established in accordance with MVSS 302.

TABLE 1
Flexible polyurethane foams: formulations (step 1)

| Polyurethane foam | | 1 | 2 |
|---|---|---|---|
| A1 | parts by wt. | 100.0 | |
| A1-1 | parts by wt. | | 75 |
| A1-2-1 | parts by wt. | | 25 |
| A2.1 (water) | parts by wt. | 4.3 | 6 |
| A2.2 (CO2) | parts by wt. | | 6 |
| A4a-1 | parts by wt. | 0.03 | 0.03 |
| A4a-2 | parts by wt. | 0.10 | 0.10 |
| A4a-3 | parts by wt. | 0.21 | 0.05 |
| A4b-1 | parts by wt. | 1.2 | |
| A4b-2 | parts by wt. | | 1.5 |
| B-1 | parts by wt. | 54.6 | 57.9 |
| Isocyanate index | | 110 | 90 |

In step 2 of the method according to the invention the polyurethane foams produced according to Table 1 were completely saturated in water glass (sodium silicate 38/40). To this end the flexible polyurethane foam from step 1 was cut into pieces and the pieces were completely immersed in a bath with water glass (sodium silicate 38/40). The entire foam was uniformly saturated with water glass.

In a third step the water glass-saturated flexible foam obtained in step 2 was rolled in a duo rolling mill (wringer) consisting of two parallel rollers. The desired degree of saturation can be adjusted selectively by adjusting the gap between the two parallel rollers or by repeating the rolling operation.

In the fourth step the wrung flexible foam was dried for 3 days at room temperature and then post-dried at 100° C. for 4 h. The characteristics of the foams obtained in this way are listed in Table 2.

TABLE 2
Impregnation of the flexible polyurethane foam produced in step 1

| | | 1x | | | | | 2x |
|---|---|---|---|---|---|---|---|
| | | (cmp) | 1a | 1b | 1c | 2a | (cmp) |
| Foam before | | | | | | | |
| saturation | | | | | | | |
| Weight | [g] | 11.4 | 9.9 | 9.8 | 9.9 | 5.3 | 5.8 |
| Density | [kg/m³] | 24.9 | 21.4 | 21.1 | 21.5 | 11.6 | 12.8 |
| Foam after rolling | | | | | | | |
| Weight | [g] | 28.9 | 40.0 | 30.5 | 301.1 | 21.3 | 14.6 |
| Density | [kg/m³] | 63.3 | 86.3 | 65.7 | 656.1 | 44.1 | 32.1 |
| Foam after rolling | | | | | | | |
| and drying at 25° C. | | | | | | | |
| Weight | [g] | 16.4 | 19.4 | 20.0 | 155.8 | 12.6 | 10.5 |
| Density | [kg/m³] | 38.4 | 42.9 | 47.4 | 354.2 | 29.6 | 23.0 |
| Foam after rolling | | | | | | | |
| and drying at 25° C. | | | | | | | |
| and after drying at | | | | | | | |
| 100° C. for 4 h | | | | | | | |
| Weight | [g] | 16.0 | 19.0 | 18.4 | 46.2 | 11.6 | 10.4 |
| Density | [kg/m³] | 37.6 | 42.0 | 43.6 | 105.0 | 27.3 | 22.8 |
| Silicon content | % | 5.3 | 8.9 | 8.7 | 14.6 | 10.1 | 8.2 |
| Fire test to MVSS | passed | no | yes | yes | yes | yes | no |
| 302 | | | | | | | |

The polyurethane foam according to composition 1 passes the fire test according to MVSS 302 with densities of 42 kg/m³ after impregnation. The polyurethane foam according to composition 2 passes the fire test according to MVSS 302 with densities of 27.3 kg/m³ after impregnation. Table 2 shows that the foams produced by the method according to the invention have significantly lower densities and weights than the hitherto known water glass-impregnated foams.

1-14. (canceled)

15. Method for producing flame-retardant polyurethane foams comprising the following steps:
Step (1) producing a flexible polyurethane foam obtainable by reacting Component A:
A1 100 parts by weight of compounds containing isocyanate-reactive hydrogen atoms and having a hydroxyl value in accordance with DIN 53240 from 3 mg KOH/g to 140 mg KOH/g,
A2.1 0.5 to 25 parts by weight, per 100 parts by weight of A1, of water,
A2.2 0 to 25 parts by weight, per 100 parts by weight of A1, of physical blowing agent,
A3 0 to 10 parts by weight, per 100 parts by weight of A1, of compounds containing optionally isocyanate-reactive hydrogen atoms and having a hydroxyl value from 140 mg KOH/g to 900 mg KOH/g,
A4 0.05 to 10 parts by weight, per 100 parts by weight of A1, of auxiliary agents and additives,
and
Component B:
B di- or polyisocyanates,
wherein production of said flexible polyurethane foam takes place with an isocyanate index from 75 to 120, and
wherein the indicated parts by weight of components A2 to A4 relate to 100 parts by weight of component A1;
Step (2) impregnating the flexible polyurethane foam produced in step (1) with aqueous sodium and/or potassium silicate solution,
Step (3) periodically compacting and/or rolling the impregnated polyurethane foam from step (2), then
Step (4) drying the polyurethane foam obtainable in accordance with step (3).

16. The method according to claim 15, wherein the auxiliary agents and additives are selected from the group consisting of catalysts, surface-active agents, pigments and flame retardants.

17. The method according to claim 15, wherein component A1 contains:
A1.1 at least one polyether polyol having a functionality from 2 to 8, an oxyethylene content of >60 wt. %, primary OH groups and a hydroxyl value in accordance with DIN 53240 from ≧10 mg KOH/g to ≦112 mg KOH/g, and
A1.2.1 at least one polyether polyol having a functionality from 2 to 8, an oxyethylene content from 0 to 30 wt. %, less than 50% primary OH groups and a hydroxyl value in accordance with DIN 53240 from ≧42 mg KOH/g to ≦56 mg KOH/g, and/or
A1.2.2 at least one polyether polyol having a functionality from 2 to 8, an oxyethylene content from 0 to 30 wt. %, more than 50% primary OH groups and a hydroxyl value in accordance with DIN 53240 from ≧28 mg KOH/g to ≦35 mg KOH/g,
the indicated parts by weight of components A1.1, A1.2.1 and A1.2.2 adding to 100.

18. The method according to claim 15, wherein component A1 contains 100 parts by weight of a polyether polyol having a hydroxyl value in accordance with DIN 53240 from 3 mg KOH/g to 140 mg KOH/g, a functionality from 2 to 8 and an oxyethylene content from 0 to 20 wt. %.

19. The method according to claim 17, wherein component A1 contains:
A1.1 60 to 90 parts by weight of a polyether polyol having a functionality from 2 to 8, an oxyethylene content of >60 wt. %, more than 50% primary OH groups and a hydroxyl value in accordance with DIN 53240 from ≧10 mg KOH/g to ≦112 mg KOH/g, and
A1.2.1 10 to 40 parts by weight of a polyether polyol having a functionality from 2 to 8, an oxyethylene content from 0 to 30 wt. %, less than 50% primary OH groups and a hydroxyl value in accordance with DIN 53240 from ≧42 mg KOH/g to ≦56 mg KOH/g, and/or
A1.2.2 10 to 40 parts by weight of a polyether polyol having a functionality from 2 to 8, an oxyethylene content from 0 to 30 wt. %, more than 50% primary OH groups and a hydroxyl value in accordance with DIN 53240 from ≧28 mg KOH/g to ≦35 mg KOH/g,
the indicated parts by weight of components A1.1, A1.2.1 and A1.2.2 adding to 100.

20. The method according to claim 15, wherein in step (1) the flexible polyurethane foam has a density of less than 25 kg/m³.

21. The method according to claim 15, wherein in step (1) the flexible polyurethane foam has a density of less than 15 kg/m³.

22. The method according to claim 15, wherein after step (4) the polyurethane foam has a density of less than 60 kg/m³.

23. The method according to claim 15, wherein after step (4) the polyurethane foam has a density of ≦45 kg/m³ and ≧38 kg/m³.

24. The method according to claim 15, wherein after step (4) the polyurethane foam has a density of ≦30 kg/m³ and ≧23 kg/m³.

25. A polyurethane foam obtainable by the method according to claim 15.

26. The polyurethane foam according to claim 25, having a density of less than 60 kg/m³.

27. The polyurethane foam according to claim 25, having a density of ≦45 kg/m³ and ≧38 kg/m³.

28. The polyurethane foam according to claim 25, having a density of ≦30 kg/m³ and ≧23 kg/m³.

29. Use of the polyurethane foams according to claim 25 in the automotive, construction and/or furniture industry.
